(19) United States
(12) Patent Application Publication
(10) Pub. No.: US 2003/0019677 A1
(43) Pub. Date: Jan. 30, 2003

(54) Motorcycle computer

(76) Inventor: Geoffrey Wotton, Battle Ground, WA (US)

Correspondence Address: SMITH-HILL AND BEDELL, 12670 N W BARNES ROAD, SUITE 104, PORTLAND, OR, 97229

(21) Appl. No.: 09/916,891

(22) Filed: Jul. 26, 2001

(51) Int. Cl. B62M 7/00; B62K 11/00

(52) U.S. Cl. 180/219; 180/218

(57) ABSTRACT

A motorcycle includes a fork, a wheel supported in the fork for rotation about an axis of rotation, a brake caliper attached to the fork, a sensor unit attached to the brake caliper for sensing rotation of the wheel, and a connection cable attached at a lower end to the sensor unit. The lower end of the connection cable is substantially perpendicular to the axis of rotation of the wheel.

### BACKGROUND OF THE INVENTION

This invention relates to a motorcycle computer.

Referring to FIGS. 1 and 2 of the drawings, a conventional motorcycle includes a front wheel with a hub 10 through which a front axle 12 extends and to which a brake rotor 14 is attached. The front axle is supported in a front fork (not shown) having left and right legs. Caliper mounting lugs project to the rear of the left leg of the front fork and a caliper plate, which carries a brake caliper, is attached to the mounting lugs.

A conventional motorcycle computer, for acquiring and displaying information relating to distance covered and speed, is mounted on or adjacent to the handlebar so that the computer's display panel can be viewed by the rider. The computer is connected to a sensor unit that is attached to the front fork for sensing rotation of the front wheel. Typically, the sensor unit includes a magnetically-sensitive reed switch having two contacts accommodated in a slim cylindrical reed switch cartridge 16. The reed switch cartridge 16 is mounted adjacent the left leg of the front fork.

Two wire leads, which are respectively connected to the contacts of the reed switch, project from the reed switch cartridge 16. A connection cable including two wires 18 connects the leads to the computer.

The brake rotor is formed with slots 20 and a cylindrical permanent magnet 22 is fitted in one of the slots 20. The slots 20 may be radial, as shown. As the front wheel rotates, the magnet moves along a circular path that is close to the reed switch cartridge. As the magnet 22 passes the cartridge 16, the magnetic field of the magnet temporarily influences the reed switch and the reed switch is momentarily closed, i.e. rendered conductive. The computer detects each change in state of the reed switch and thus counts wheel revolutions.

Conventionally, the reed switch cartridge 16 is mounted in a cylindrical protective housing (not shown) with its central axis parallel to the central axis of the cylindrical protective housing, and the housing is positioned with its central axis parallel to the axis of rotation of the wheel. Accordingly, the central axis of the reed switch cartridge is parallel to the axis of rotation of the wheel. When the reed switch cartridge is oriented in this manner, the switch is closed only once per revolution of the wheel. This is advantageous with respect to accurate counting of revolutions of the wheel.

The connection cable including the wires 18 passes from the protective housing up to the vicinity of the handlebar for connection to the computer through a protective flexible tube which is attached at one end to the protective housing. Any bends in the protective tube must typically have a radius of at least 10 mm in order to avoid kinking.

This conventional arrangement is subject to disadvantage, particularly when applied to motorcycles that are used on rough terrain, because the orientation of the protective cylindrical housing and the need to avoid sharp bends in the protective tube result in the protective tube extending outboard of the left leg of the front fork by a significant distance. On rough terrain, the tube may catch on brush and may strike rocks and other hard objects, resulting in damage to the tube or to the connection cable or even in the sensor unit being torn from the fork.

### SUMMARY OF THE INVENTION

In accordance with a first aspect of the invention there is provided a motorcycle including a fork, a wheel supported in the fork for rotation about an axis of rotation, a brake caliper attached to the fork, a sensor unit attached to the brake caliper for sensing rotation of the wheel, and a connection cable attached at one end to the sensor unit, said one end of the connection cable being substantially perpendicular to the axis of rotation of the wheel.

In accordance with a second aspect of the invention there is provided a motorcycle including a fork, a wheel supported in the fork for rotation about an axis of rotation, a brake caliper attached to the fork, a sensor unit attached to the brake caliper for sensing rotation of the wheel, and a connection cable attached at one end to the sensor unit, said one end of the connection cable lying in a plane that is substantially perpendicular to the axis of rotation of the wheel.

### BRIEF DESCRIPTION OF THE DRAWINGS

For a better understanding of the invention, and to show how the same may be carried into effect, reference will now be made, by way of example, to the accompanying drawings, in which

FIG. 1 is a partial perspective view of the front wheel of a motorcycle,

FIG. 2 is an enlarged view of a detail of FIG. 1,

FIG. 3 is a side view of the front wheel of a motorcycle in accorcance with the present invention,

FIG. 4 is a view of the front wheel from a point above the wheel and to the rear of the front fork, and

FIG. 5 is an enlarged partial view of the front wheel taken on the line 5-5 of FIG. 4.

In the several figures of the drawings, like reference numerals designate like or corresponding elements.

### DETAILED DESCRIPTION

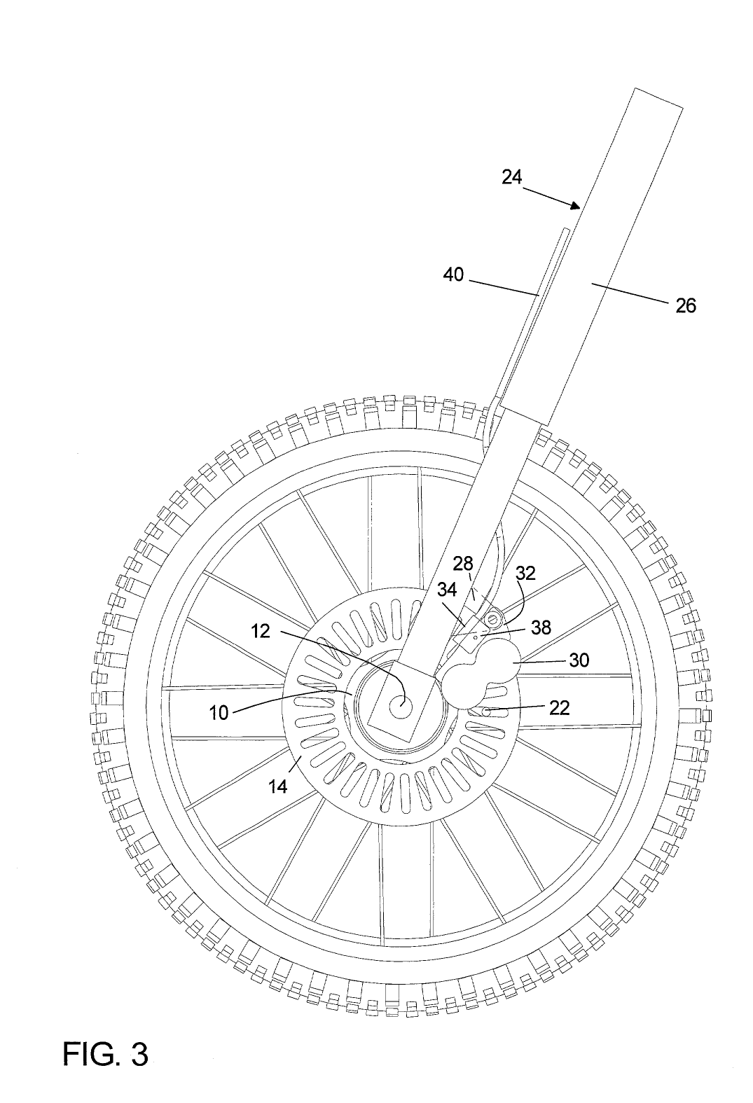

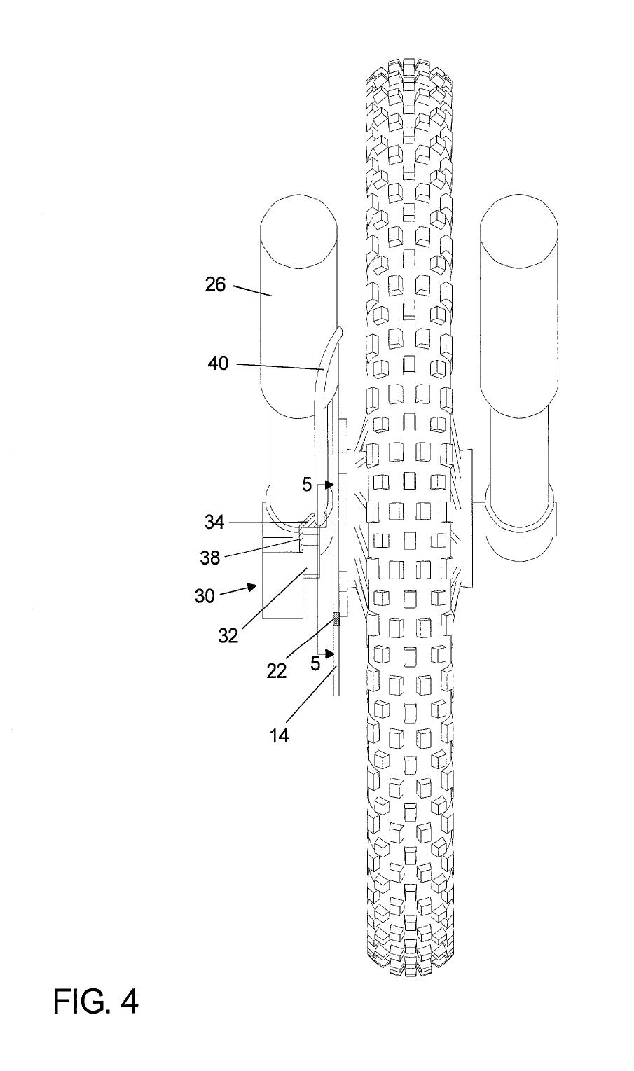

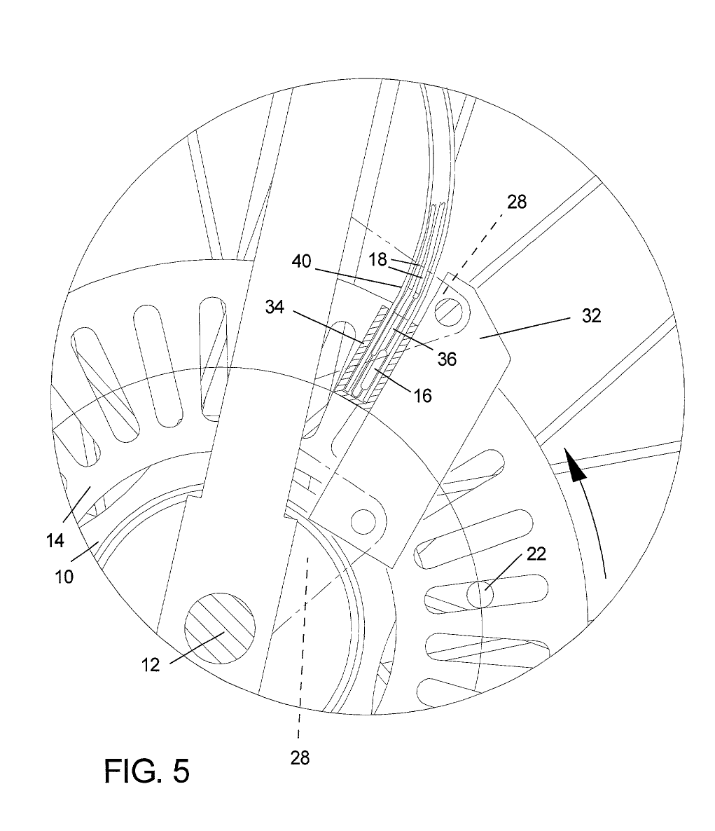

FIGS. 3, 4 and 5 illustrate a motorcycle front fork 24 supporting the axle 12. The front fork 24 includes a left leg 26. Caliper mounting lugs 28 project to the rear of the left leg 26, and a brake caliper 30, including a brake caliper plate 32, is attached to the caliper mounting lugs 28. A brake cable (not shown) passes from the brake caliper 30 up to the handlebar. The brake cable passes close to the left fork leg 26 and does not extend outboard of the left leg to a significant extent. Consequently, the brake cable is not subject to damage when the motorcycle is ridden on rough terrain.

A sensor unit includes a bracket 34 made of injection-molded synthetic polymer material. The bracket is formed with a blind cylindrical chamber 36 having a central axis. The reed switch cartridge 16 is positioned in the chamber 36 with the central axis of the reed switch cartridge parallel to the central axis of the cylindrical chamber 36.

The sensor unit bracket 34 includes a flange 38 and the central axis of the reed switch cartridge lies in a plane parallel to and spaced from the flange 38. The flange 38 has a hole to facilitate attachment of the bracket 34 to the caliper plate 32. The flange is provided with a reference mark at a position related to the location of the reed switch cartridge.

The caliper plate 32 is substantially perpendicular to the axis of rotation of the front wheel and the sensor unit bracket 34 is attached to the caliper plate 32 with the flange 38 in parallel confronting relationship with the caliper plate. Therefore, the central axis of the reed switch cartridge 16 is substantially perpendicular to the axis of rotation of the front wheel. The configuration of the sensor unit bracket 34, with the chamber 36 offset from the flange 38 parallel to the axis of rotation of the wheel, places the reed switch cartridge 16 sufficiently close to the rotor for the reed switch to be influenced by the magnet 22 as the wheel rotates. The radial position of the sensor unit bracket 34 is selected so that the reference mark is at substantially the same radial distance from the axis of rotation of the front wheel as the center of the magnet. The location of the reference mark relative to the reed switch cartridge is selected so that, when viewed along the axis of rotation of the front wheel, the reed switch cartridge is at the outer periphery of the annular area swept by the magnet. Observation of this relationship ensures that the reed switch closes only once each time the magnet passes the sensor unit bracket. Incorrect positioning of the sensor unit bracket along the radius of the wheel relative to the path of movement of the magnet may lead to the reed switch being closed and opened twice each time that the magnet passes the sensor unit bracket.

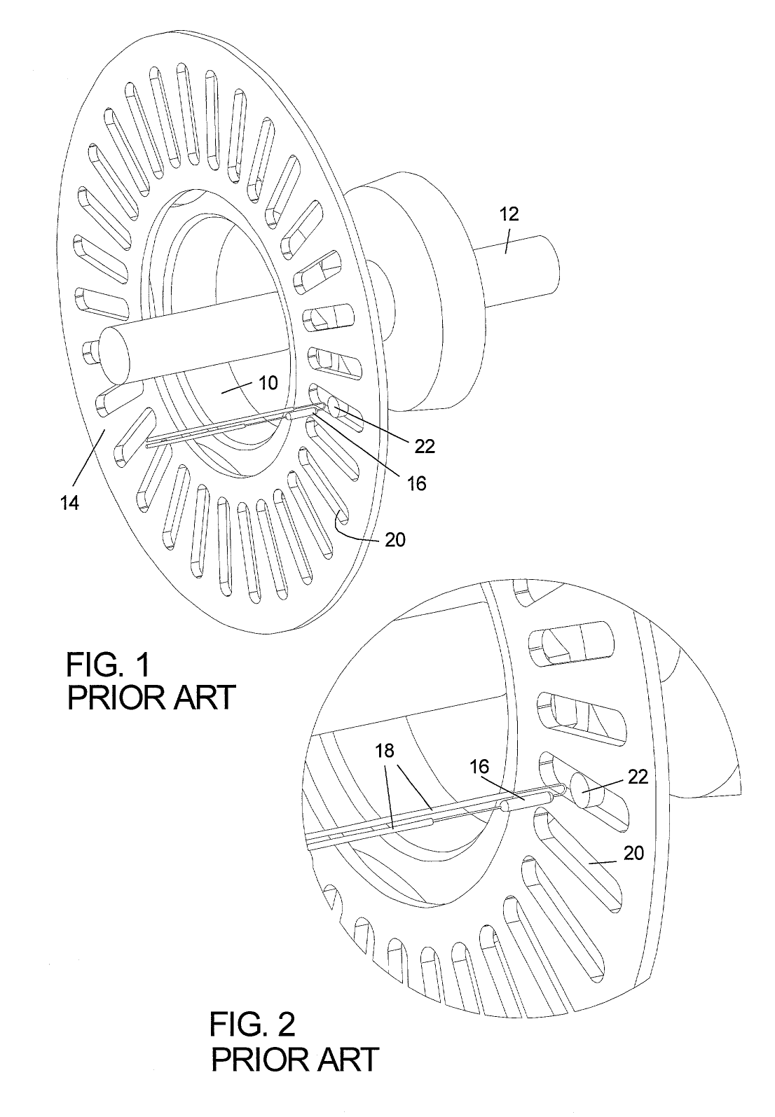

The chamber 36 is open upwards and the lower end of the protective tube 40 is fitted in the open upper end of the chamber 36. The bracket 34 is oriented so that the central axis of the chamber 36 lies in a plane that is substantially perpendicular to the axis of rotation of the front wheel. Consequently, it is not necessary for the protective tube, at its lower end, to extend parallel to the axis of rotation of the wheel and the likelihood of damage to the protective tube or to the sensor unit is substantially reduced relative to the prior art described with reference to FIGS. 1 and 2.

The central axis of the chamber 36 is within a few degrees of parallel to the left leg 26 of the front fork 24. The protective tube 40 passes up to the vicinity of the handlebar adjacent to the brake cable. The protective tube may be fitted in the same guides as the brake cable.

It will be appreciated that the invention is not restricted to the particular embodiment that has been described, and that variations may be made therein without departing from the scope of the invention as defined in the appended claims and equivalents thereof. For example, by suitable design of the sensor unit bracket the reed switch cartridge may be positioned parallel to the axis of rotation of the wheel, which would be favorable with respect to ensuring that the switch closes only once for each wheel revolution, yet still have the lower end of the protective tube perpendicular to the axis of rotation of the wheel. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated.

1. A motorcycle including a fork, a wheel supported in the fork for rotation about an axis of rotation, a brake caliper attached to the fork, a sensor unit attached to the brake caliper for sensing rotation of the wheel, and a connection cable attached at one end to the sensor unit, said one end of the connection cable being substantially perpendicular to the axis of rotation of the wheel.

2. A motorcycle according to claim 1, wherein the fork has two legs at opposite respective sides of the wheel, the motorcycle includes a brake caliper mounting lug secured to one of the legs, the brake caliper includes a brake caliper plate attached to the mounting lug, and the sensor unit is attached to the brake caliper plate.

3. A motorcycle according to claim 2, wherein the sensor unit includes a bracket having a flange and a screw that clamps the flange against the brake caliper plate.

4. A motorcycle according to claim 3, wherein the sensor unit includes a reed switch cartridge, the bracket includes a body portion formed with a chamber, and the reed switch cartridge is located in said chamber.

5. A motorcycle according to claim 1, wherein the sensor unit includes a magnetically responsive reed switch and the motorcycle includes a permanent magnet attached to the wheel at a location such that when the wheel rotates about its axis, the reed switch closes once for each revolution of the wheel.

6. A motorcycle according to claim 1, wherein the sensor unit includes a magnetically responsive reed switch, the motorcycle includes a permanent magnet attached to the wheel at a location such that permanent magnet influences the reed switch when the wheel rotates about its axis, the reed switch is incorporated in a generally cylindrical reed switch cartridge having a central axis, and the reed switch cartridge is oriented with its central axis substantially parallel to the axis of rotation of the wheel.

7. A motorcycle according to claim 1, wherein the connection cable is fitted within a protective tube.

8. A motorcycle including a fork, a wheel supported in the fork for rotation about an axis of rotation, a brake caliper attached to the fork, a sensor unit attached to the brake caliper for sensing rotation of the wheel, and a connection cable attached at one end to the sensor unit, said one end of the connection cable lying in a plane that is substantially perpendicular to the axis of rotation of the wheel.

9. A motorcycle according to claim 8, wherein the sensor unit includes a reed switch and the connection cable accommodates at least two wires connected to respective terminals of the reed switch.

10. A motorcycle according to claim 8, wherein the connection cable is fitted within a protective tube.
